(19) United States
(12) Patent Application Publication
(10) Pub. No.: US 2017/0137322 A1
(43) Pub. Date: May 18, 2017

(54) GEOPOLYMER AGGREGATES

(71) Applicant: Arizona Board of Regents on behalf of Arizona State University, Scottsdale, AZ (US)

(72) Inventor: Dong-Kyun Seo, Chandler, AZ (US)

(21) Appl. No.: 15/317,375

(22) PCT Filed: Jun. 11, 2015
(86) PCT No.: PCT/US2015/035267

§ 371 Date: Dec. 8, 2016

Related U.S. Application Data
(60) Provisional application No. 62/011,261, filed on Jun. 12, 2014.

(51) Int. Cl. C04B 14/04; A01N 59/00; C09C 1/40; A01N 25/08; B01J 20/16; C09K 21/02

(52) U.S. Cl. CPC C04B 14/044; B01J 20/165; C09K 21/02; C09C 1/405; A01N 25/08; A01N 59/00

(57) ABSTRACT

A composition including porous aggregates. The porous aggregates include alumino silicate nanoparticles. The alumino silicate nanoparticles have an average particle size between about 5 nm and about 60 nm, and a majority of the porous aggregates have a particle size between about 50 nm and about 1 μm. In addition, a majority of the pores between the aluminosilicate nanoparticles in the porous geopolymer aggregates have a pore width between about 2 nm and about 100 nm.

### CROSS-REFERENCE TO RELATED APPLICATION

This application claims priority to U.S. Patent Application Ser. No. 62/011,261 entitled “GEOPOLYMER AGGREGATES” and filed on Jun. 12, 2014, which is incorporated herein by reference in its entirety.

### TECHNICAL FIELD

This invention relates to dispersible aggregates of alkali-activated aluminosilicates and modified alkali-activated aluminosilicates and the materials that contain the aggregates.

### BACKGROUND

Geopolymers are commonly referred to by a variety of terms, including low-temperature aluminosilicate glass, alkali-activated cement, geocement, alkali-bonded ceramic, inorganic polymer concrete, and hydroceramic. Despite this variety of nomenclature, these terms all describe materials synthesized utilizing the same chemistry, which can be described as a complex system of coupled alkali-mediated dissolution and precipitation reactions of aluminosilicates in an aqueous reaction substrate. Geopolymers are nanomaterials that exhibit a dense gel-like structure with 5 nm to 60 nm-sized amorphous aluminosilicate particles. Their chemical structure generally includes an amorphous, three-dimensional network of corner-sharing aluminate and silicate tetrahedra, with the negative charge due to Al³⁺ ions in the tetrahedral sites balanced typically by the alkali metal ions. Alkali-activated aluminosilicates are a type of geopolymer. Geopolymers can be prepared typically by curing geopolymer resins. In some cases, geopolymer resins are prepared by coupled alkali-mediated dissolution and precipitation reactions of silicate or aluminosilicate precursors in an aqueous media. The term “geopolymerization process” used herein includes chemical processes that provide a geopolymer. As used herein, “geopolymer resin” includes uncured or partially cured alkali-activated aluminosilicates from the geopolymerization process.

### SUMMARY

In a first general aspect, a composition includes porous aggregates. The porous aggregates include aluminosilicate nanoparticles. The aluminosilicate nanoparticles have an average particle size between about 5 nm and about 60 nm, and a majority of the porous aggregates have a particle size between about 50 nm and about 1 μm. In addition, a majority of the pores between the aluminosilicate nanoparticles in the porous geopolymer aggregates have a pore width between about 2 nm and about 100 nm.

In a second general aspect, an aqueous medium, organic medium, polymeric medium, or elastomeric medium includes porous aggregates of the first general aspect.

In a third general aspect, a material includes the porous aggregates of the first general aspect.

In a fourth general aspect, an article includes the porous aggregates of the first general aspect.

Implementations of these general aspects may include one or more of the following features.

In some cases, the mesopore volume of the porous aggregates is at least about 0.05 cc/g, at least about 0.1 cc/g, at least about 0.2 cc/g, or at least about 0.3 cc/g on the BJH cumulative pore volume from the desorption branch of the N₂ sorption isotherm, wherein the mesopore volume is the total pore volume of the pores having a pore width from about 2 to about 50 nm. The mesopore volume of the porous aggregates may contribute at least about 50%, at least about 60%, at least about 70%, at least about 80%, or at least about 90% of the total pore volume of the aggregates from the pores having a pore width between about 2 nm and about 100 nm based on the BJH cumulative pore volume from the desorption branch of the N₂ sorption isotherm. In some cases, the specific external surface area of the porous aggregates is between about 10 m²/g and about 300 m²/g, wherein the specific external surface area of the porous aggregates is the total specific surface area minus the specific micropore surface area. In certain cases, the specific micropore surface area of the porous aggregates is between about 100 m²/g and about 700 m²/g and the aluminosilicate has zeolitic micropores.

In some implementations, the porous aggregates are formed during formation of the aluminosilicate nanoparticles. The aluminosilicate nanoparticles of each of the porous aggregates may be interconnected through chemical bonds throughout the formation of the porous aggregates. The porous aggregates may be formed in a geopolymerization process.

The porous aggregates may be formed by a process including providing a geopolymer resin containing up to about 85 mol % water; optionally keeping the geopolymer resin at a temperature up to about 60° C. for a up to about a week; heating the geopolymer resin in a closed container at a temperature up to about 100° C. for up to about a week to yield a semi-liquid or a semi-solid; removing the heat and treating the semi-liquid or the semi-solid to form a dispersion or suspension comprising the porous aggregates and reducing the pH of the dispersion or suspension to a range from about 3 to about 10; and optionally concentrating a solid component or collecting a solid product from the dispersion or suspension. The geopolymer resin may include an organic functional group. Reducing the pH may be achieved by combining the dispersion or suspension with a solution of a metal ion that forms an oxide, hydroxide, hydrous oxide, or combination thereof in contact with hydroxide ions.

In some implementations, the porous aggregates exhibit zeolitic micropores. In certain implementations, the aluminosilicate nanoparticles exhibit zeolitic micropores. The aluminosilicate nanoparticles may exhibit zeolitic micropores with a SOD, FAU, EMT, or LTA structure.

In some implementations, the porous aggregates are modified so that the pore surface of the porous aggregates is covered or impregnated partially or completely with one or more organic molecules, surfactants, or polymers or a combination thereof and/or the porous aggregates are modified so that the pore surface of the porous aggregates is covered partially or completely with inorganic molecules or nanoparticles and/or the porous aggregates are modified so that the pores of the porous aggregates are impregnated partially or completely with nanoparticles and/or the porous aggregates are modified so that the pores of the porous aggregates are impregnated partially or completely with molecules of a biological origin and/or the porous aggregates are modified so that the alkali ions in the aluminosilicate aggregates are exchanged partially or completely with other metal ions or protons.

In certain implementations, the porous aggregates absorb or emit a light in the visible light range.

In some cases, the porous aggregates absorb water or moisture and/or the porous aggregates absorb oil or organic molecules and/or the porous aggregates neutralize or scavenge an acid and/or the porous aggregates retard fire propagation and/or the porous aggregates release metal ions or metal nanoparticles that have an antibacterial effect.

The porous aggregates may contain up to about 0.5 wt % conjugate anions of an acid including sulfates, nitrates, chlorides, and acetates.

In some cases, the absolute value of the zeta potential of the porous aggregates is at least about 30 mV, at least about 40 mV, at least about 50 mV or at least about 60 mV in the pH range not lower than about 3, about 4 or about 5 and not higher than about 14, about 13 or about 12.

In some cases, the porous aggregates provide a thixotropic property to the aqueous medium, organic medium, polymeric medium, or elastomeric medium of the second general aspect.

In some cases, the material of the third general aspect is an adhesive, a sealant, a colorant, an ink, an ink for ink-jet printers, a toner, a paint, a coating, a defoamer, a grease, a paper, a cement, a thermal insulating material, a sound proof, a rubber, a silicone rubber, a plastic, an animal feed, an animal nutrient, an antibiotic, an antimicrobial agent, a fertilizer, a pesticide, a gel, an antacid, a food item, a fire retardant, a cosmetic, a cream, a lotion, a sealing agent, an adsorbent, a gas adsorbent, a carbon dioxide adsorbent or separator, a gas purifier, a deodorant, a detergent, a cat litter, a catalyst, an oxygen concentrator, an ion exchanger, a sulfur scavenger, an acid scavenger, a radionuclide sorbent, or a desiccant. In certain cases, the material of the third general aspect is in the form of a liquid, a semi-liquid, a paste, a semi-solid, powder, granules, beads, pellets, film, coating, fibers, hollow fibers, wires, strings, tubing, foams, or monoliths.

In some implementations, the article of the fourth general aspect includes a tire, a rubber belt, a rubber seal, a rubber tube, footwear, a polystyrene foam, a polyurethane foam, a fire extinguisher, a tooth paste, a drug tablet, a membrane, a dehumidifier, or a heat exchanger.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart showing a process for forming geopolymeric aluminosilicate particles.

FIG. 2 shows a transmission electron micrograph of the dried product formed in Example 1.

FIG. 3 shows the dynamic light scattering particle size distribution of the wet product formed in Example 2.

FIG. 4 shows the dynamic light scattering particle size distribution of the freeze-dried product formed in Example 5.

FIG. 5 shows a photograph of the methylene-blue-treated product (right) formed in Example 3 and the original product formed in Example 1 after drying and crushing.

FIG. 6 shows a photograph of a dispersion of methylene-blue-treated product (right) formed in Example 3 in extra-heavy paraffin oil.

FIG. 7 shows the dynamic light scattering particle size distribution of the wet product formed in Example 6.

FIG. 8 shows the dynamic light scattering particle size distribution of the freeze-dried sample re-dispersed in water formed in Example 6.

FIG. 9 shows the powder X-ray diffraction pattern of the freeze-dried sample formed in Example 6.

FIG. 10 shows N₂ sorption isotherms of the freeze-dried sample (upper curve) along with the oven-dried sample (lower curve) formed in Example 6.

FIG. 11 shows Brunauer-Emmett-Teller (BJH) pore size distributions of the freeze-dried sample (upper curve) along with the oven-dried sample (lower curve) formed in Example 6.

FIG. 12 shows Brunauer-Emmett-Teller (BJH) cumulative pore volume as a function of the pore width of the freeze-dried sample (upper curve) along with the oven-dried sample (lower curve) formed in Example 6.

FIG. 13 shows the dynamic light scattering particle size distributions of the oven-dried sample formed in Example 8 dispersed in methanol and water.

FIG. 14 shows the dynamic light scattering particle size distribution of the sample formed in Example 9 dispersed in water.

FIG. 15 shows a scanning electron micrograph of the sample formed in Example 9.

FIG. 16 shows the dynamic light scattering particle size distribution of the sample formed in Example 10 dispersed in water.

### DETAILED DESCRIPTION

Aluminosilicates formed by geopolymerization are also known as “alkali-activated aluminosilicates,” “geopolymeric aluminosilicates,” or “aluminosilicate geopolymers.” Production of aluminosilicate materials through geopolymerization can be advantageous because of the high production yield per reactor volume and use of inexpensive precursors such as clays and calcined clays. Synthesis of these aluminosilicates includes formation of aluminosilicate geopolymer by coupled alkali-mediated dissolution and condensation reactions of highly concentrated silicate or aluminosilicate precursors in an aqueous media. In some examples, metakaolin or metakaolinite is reacted with an alkaline solution to form a geopolymer resin. In some examples, kaolin or kaolinite are reacted with an alkaline solution to form a geopolymer resin. A geopolymer resin typically includes water and high concentrations of dissolved, dispersed, or suspended inorganic species. The high concentrations of the precursors typically lead to a relatively high viscosity and a visual homogeneity of the geopolymer resin. Geopolymer resins are described in U.S. 2013/0055024, entitled “POROUS GEOPOLYMER MATERIALS,” which is incorporated herein by reference.

Geopolymer precursors may include organic functional groups. For example, WO 2005/054340, entitled “HYBRID INORGANIC POLYMER SYSTEMS,” which is incorporated herein by reference, describes inorganic polymers that include Si—O—Al bonds and also organic functional groups. In one embodiment, an inorganic polymer includes one or more organic functional groups and has the following empirical formula:

Rₘ[M₂O]ₓ[Al₂O₃]_{y}[SiO₂]_{z}X_{q}.nH₂O

in which R represents an organic functional group, M represents an alkali metal, and X represents chlorine or fluorine.

Aggregates referred to herein follow the IUPAC recommendation in Pure and Applied Chemistry 79, 1801-1829 (2007), which is incorporated by reference herein. That is, as used herein, “aggregates” refer to clusters of “primary particles” (also referred to as “elementary particles”) interconnected by chemical bonds, and do not break down or disintegrate typically by a mechanical treatment. Aggregates may also be referred to as “secondary particles.”

Pores defined by the porous geopolymer materials can include micropores (i.e., pores with a pore size less than about 2 nm), mesopores (i.e., pores with a pore size between about 2 nm and about 50 nm), macropores (i.e., pores with a pore size greater than about 50 nm), or any combination thereof. In some cases, pores defined by the porous materials include a majority or a significant majority of mesopores or open mesopores. In some cases, pores defined by the porous materials include a majority or a significant majority of macropores or open macropores. In certain cases, pores defined by the porous materials include mesopores and macropores. In this disclosure, the terms “pore width,” “pore size,” and “pore diameter,” are used interchangeably.

Zeolites are typically described as crystalline aluminosilicates having ordered channel and/or cage structures and containing micropores (“zeolitic micropores”) which are typically smaller than about 0.9 nm. The network structure of such zeolites consists of SiO₄ and AlO₄ tetrahedra that share oxygen bridges.

Geopolymer materials are typically produced into a hard monolithic form by curing a geopolymer resin. In some cases, geopolymer materials are obtained as particulates. For example, WO 2013/044016, entitled “GEOPOLYMER RESIN MATERIALS,” which is incorporated herein by reference, describes forming geopolymer particulates by contacting a geopolymer resin or geopolymer with a fluid and removing at least some of the fluid. The resulting particulates have one or more external dimensions ranging in size from about 0.1 μm to about 100 μm, from about 100 μm to about 5000 μm, or from about 5 mm to about 2 cm. As used herein, “about” refers to ±10% (e.g., about 100° C. refers to a range of temperatures between 90° C. and 110° C.) The aluminosilicate particulates produced by the processes may exhibit a nanoporous structure with a majority of pores having a pore width between 2 and 100 nm among the pores when their pore volume contribution and their distribution are estimated with Brunauer-Emmett-Teller (BJH) analysis of the desorption branch of the N₂ gas sorption isotherm. In some cases, a majority of the pores are mesopores. The total specific surface area of the geopolymeric aluminosilicates may be from about 10 to about 700 m²/g based on the Brunauer-Emmett-Teller (BET) analysis of the N₂ sorption isotherm. The specific micropore surface area of the geopolymeric aluminosilicates may be from about 0 to about 700 m²/g based on the t-plot analysis. In some cases, the specific external surface area of the geopolymeric aluminosilicates is estimated to be about 10 to about 300 m²/g by subtracting the specific micropore surface area from the total specific surface area (BET surface area).

The zeolitic crystallinity of geopolymeric aluminosilicates may be controlled during synthesis. Such control may include, for example, use of a variety of reagents, including organic template molecules such as quaternary ammonium ions. Aluminosilicate geopolymer materials are resistant to acids, which may allow a more flexible condition for modification of materials, especially materials that include an acidic component. The aluminosilicate geopolymer materials are generally stable in water and do not undergo gelation over time, thus allowing flexibility with respect to material handling and transfer. Accordingly, geopolymeric aluminosilicates are suitable for applications such as fillers, pigments and reinforcing fillers for rubber compounds, plastics, paper and paper coating compositions, paints, adhesives, and the like. Such fillers typically have an external dimension no larger than 1 μm and exhibit a relatively high surface area.

As described herein, aluminosilicate nanoparticles (“primary particles”) may remain aggregated while they are forming to yield porous aggregates (“secondary particles”). An average primary particle size of the aluminosilicate nanoparticles is between about 5 nm and about 60 nm, and a majority of the porous aggregates have a particle size between about 50 nm and about 1 μm. In some cases, the aluminosilicate primary particles are porous. In certain cases, a majority of the pores between the aluminosilicate primary particles in the porous aggregates have a pore width between about 2 nm and about 100 nm. In some cases, the porous aggregates are formed during formation of the primary particles. In certain cases, the aluminosilicate nanoparticles of each porous aggregate are interconnected through chemical bonds throughout the formation of the porous aggregate.

The average particle size of the primary particles can be estimated by using various characterization methods including transmission electron microscopy and gas sorption studies. The average particle size of the secondary particles can be estimated by using various characterization methods including scanning electron microscopy and dynamic light scattering. The dynamic light scattering methods provide the particle size as a hydrodynamic particle diameter and are applicable to particles in a dispersion. Various methods are available in calculating the average particle sizes from dynamic light scattering experiments. Z-average, Z-average size, or Z-average mean used in dynamic light scattering is a parameter also known as the cumulants mean. The Z-average mean is often used in a quality control setting as it is defined in ISO 13321 and 22412.

In some cases, the mesopore volume (i.e., the total pore volume from the pores having a pore width between 2 nm and 50 nm) of the aggregates is at least about 0.05 cc/g, at least about 0.1 cc/g, at least about 0.2 cc/g, or at least about 0.3 cc/g on the BJH cumulative pore volume from the desorption branch of the N₂ sorption isotherm. In some cases, the mesopore volume of the aggregates contributes at least about 60%, at least about 70%, or at least about 80% of the total pore volume of the aggregates from the pores having a pore width from 2 to 100 nm based on the BJH cumulative pore volume from the desorption branch of the N₂ sorption isotherm. In some cases, the specific external surface area (i.e., total specific surface area minus specific micropore surface area) of the aggregates is at least about 10 m²/g and no greater than about 300 m²/g. In certain cases, the specific micropore surface area of the aggregates is at least about 100 m²/g and no greater than about 700 m²/g, and the aluminosilicate is zeolitic.

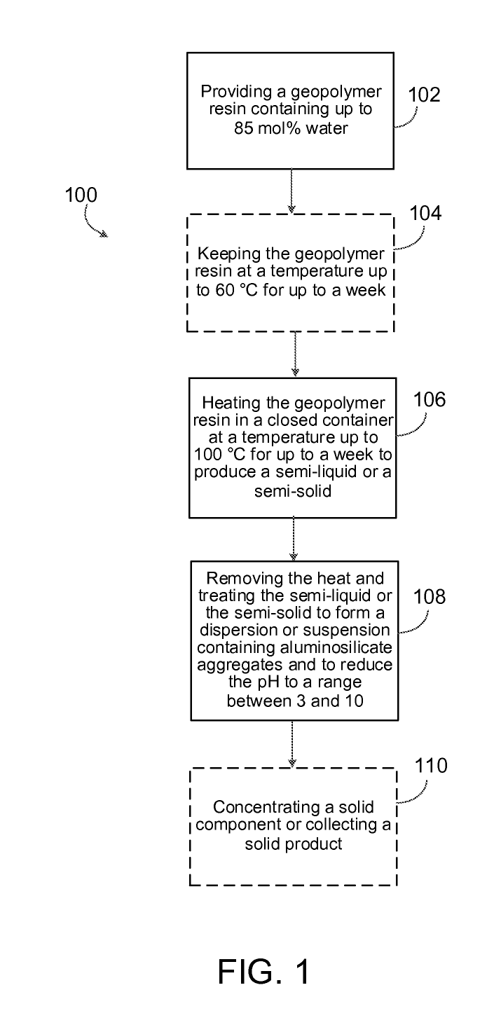

As depicted in the flowchart in FIG. 1, a process 100 for forming porous aluminosilicate aggregates from a geopolymer resin includes (102) providing a geopolymer resin containing up to about 85 mol % water; (104) optionally keeping the geopolymer resin at a temperature up to about 60° C. for up to a week; (106) heating the geopolymer resin in a closed container at a temperature up to about 100° C. for up to a week to produce a semi-liquid or a semi-solid; (108) removing the heat and treating the semi-liquid or the semi-solid to form a dispersion or suspension containing porous aluminosilicate aggregates and to reduce the pH to a range between 3 and 10; and (110) optionally concentrating a solid component or collecting a solid product including the porous aluminosilicate aggregates.

Herein, a semi-liquid is defined as a fluid having a thick consistency between solid and liquid, and a semi-solid is defined as a wet or partially wet solid that can be disintegrated or dispersed when it is in contact with a liquid. The semi-liquid or semi-solid may be formed by partially curing a geopolymer resin. Partial curing of a geopolymer resin can occur with short curing times (several hours or a day, for example) or low curing temperatures (at room temperature, for example). In some cases, partial curing occurs when a large amount of water or alkali is present in a geopolymer resin or when an organic component is present in the geopolymer resin. Elevated temperatures typically accelerate curing. In some cases, the temperature is varied during curing. In certain cases, a geopolymer resin is kept at a certain temperature (room temperature, for example) for a length of time (i.e., “aged”) before curing or partially curing. In some cases, a geopolymer resin is aged after curing or partially curing.

The semi-liquid or the semi-solid may be in the form of a cake, a paste, or a slurry. Forming the dispersion or suspension from the semi-liquid or semi-solid may include, for example, a mechanical treatment such as shaking, shearing, homogenizing, agitating, stirring, ultrasonication, or a combination thereof. A dispersant or dispersion stabilizer may be added to facilitate the mechanical treatment. In some cases, reducing the pH may be carried out by repetitive water exchange, adding an acid, ion exchange, or a combination thereof.

The dispersion or suspension may be treated chemically. In some cases, the dispersion or suspension includes an organic, inorganic or biological component which can modify the aggregates in the dispersion or suspension. Such modification may include, for example, impregnation of the organic, inorganic or biological component into the aggregates; deposition or coating of the organic, inorganic, or biological component onto the internal and/or external surface of the aggregates; and the like. The impregnation, deposition, or coating may be induced by electrostatic attraction or covalent crosslinking between the surface moieties of the aggregates and the organic, inorganic or biological component. In some cases, the modification includes ion exchange; that is, the alkali ions in the aluminosilicates are exchanged partially or completely by other metal ions or protons present in the dispersion or suspension. Treatment of the aggregates may make the aggregates hydrophobic, change the point of zero charge (PZC) or the zeta potential of the aggregates, alter the optical properties of the aggregates, alter the surface properties, provide cross-linking moieties on the surface, impart antimicrobial properties to the aggregates, or a combination thereof. The surface charge of particles in water correlates to the stability of their aqueous dispersion. When the absolute value of a measured zeta potential is in the range of 0-5 mV, there can be rapid coagulation/agglomeration among the particles; 10-30 mV may represent an incipient instability of the dispersion; 30-40 mV may represent a moderate stability; 40-60 mV may represent a good stability; and ≧60 mV may signify an excellent stability.

Concentrating the solid component may be carried out by filtration, water evaporation or centrifugation. Concentrating the solid component may be helped by adding a flocculant, a coagulant, or a surfactant. Collecting the solid product may be carried out by filtration, rinsing, and subsequent drying to yield aluminosilicate aggregates in the form of a powder or granules. Drying may include, for example, ambient drying, spay drying, drying by heating, freeze drying, or a combination thereof. In some cases, freeze drying can lead to a lesser degree of agglomeration in the dried product than ambient drying and drying by heating. The solid product may be further ground, milled, or pulverized.

The resulting aluminosilicate aggregates may have zeolitic micropores. In some cases, the aluminosilicate aggregates may have zeolitic micropores exhibiting a sodalite (SOD), faujasite (FAU), EMC-2 (EMT), or zeolite A (LTA) type structure.

Modification of the aluminosilicate aggregates may result in a significant portion of the pore surface of the aluminosilicate aggregates being covered or coated with organic molecules, surfactants, polymers, inorganic molecules, nanoparticles, or a combination thereof. In certain cases, modification results in a significant portion of the pores of the aluminosilicate aggregates being impregnated with nanoparticles or with molecules of a biological origin. In some cases, modification of the aluminosilicate aggregates results in exchange of a significant portion of the alkali ions in the aluminosilicate aggregates with other metal ions or protons.

In some cases, the aluminosilicate aggregates or the modified aluminosilicate aggregates absorb water, moisture, oil, organic molecules, or a combination thereof. The aluminosilicate aggregates or the modified aluminosilicate aggregates may neutralize or scavenge an acid, retard fire propagation, or release metal ions or metal nanoparticles that have an antibacterial effect. The aluminosilicate aggregates or the modified aluminosilicate aggregates may act as a colorant or a sun-block agent. The modified aluminosilicate aggregates may absorb a light in the visible light range (from about 390 nm to about 700 nm).

The aluminosilicate aggregates or the modified aluminosilicate aggregates may be mixed with a material to form a mixture. The material may partially or completely fill pores in the aluminosilicate aggregates. In some cases, the material is, for example, water, an aqueous solution, an organic solvent, an organic solution, an organic polymer, an organic polymer melt, or a combination thereof. In certain cases, the material is or includes cellulose, paint, adhesives, paper, cosmetics, medicine, or natural or synthetic rubber (e.g., for use in tires). The incorporation of the aluminosilicate aggregates or the modified aluminosilicate aggregates in rubber compositions used for the manufacture of tires and tire components may result in a reduction in the rolling resistance, an improvement in adhesion to wet, snow-covered or icy ground, an increase in wear resistance and/or a reduction of curing time of the rubber compositions.

The aluminosilicate aggregates or the modified aluminosilicate aggregates may enhance or retard the polymerization or cross-linking of the organic component in the mixture. In some cases, the mixing is designed in such a way that the solid product disagglomerates sufficiently. The mixing may be helped by shaking, shearing, homogenizing, agitating, stirring, sonicating, vibrating, crushing, pounding, grinding, pulverizing, milling, crumbling, smashing, mashing, pressing, or triturating.

The mixing may be carried out in combination with addition of an additive. The additive may serve as a cross-linker between the aluminosilicate and an organic polymer or an elastomer. In some cases, the mixture includes an inorganic component. In certain cases, the mixture is biological in origin. In one example, the mixture is a fertilizer. In other examples, the mixture is a pesticide, a fungicide, a herbicide, an antibiotic, or the like. In still other examples, the mixture is a polymer foam or porous material including a polymer. The aluminosilicate aggregates or the modified aluminosilicate aggregates in the mixture may reduce the thermal conductivity of the polymeric foam or porous material.

The following examples are provided for illustration. It should be appreciated by those of skill in the art that the techniques disclosed in the following examples are considered to be exemplary. However, those of skill in the art should, in light of the present disclosure, appreciate that many changes can be made in the specific embodiments that are disclosed without departing from the spirit and scope of this disclosure.

### Examples

### Example 1

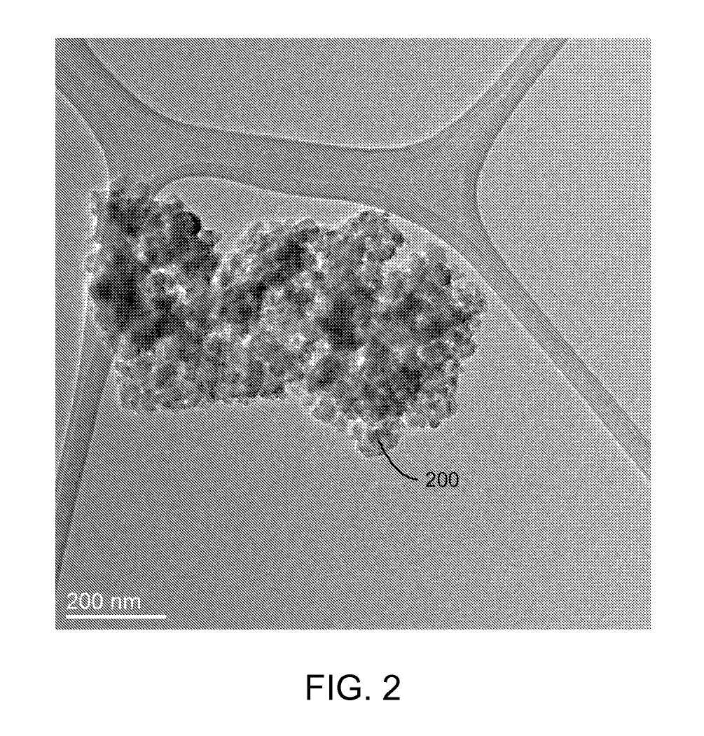

6 g of NaOH was dissolved in 11 ml of deionized water in an ice bath. 15.5 g of sodium silicate (˜10.6% Na₂O, ˜26.5% SiO₂) was added subsequently into the above solution and stirred in a water bath with a laboratory mixer at 800 rpm, until the solution became homogeneous by visual inspection. Into the solution, 7.6 g of metakaolin (MetaMax®) was added and stirring was continued at 800 rpm for about 40 min, which yielded a geopolymer resin having approximate nominal Na:Al:Si atomic ratios of 3:1:2. This geopolymer resin was poured into a polypropylene tube, sealed airtight, and heated at 60° C. for six hours in a lab oven to give a paste-like geopolymer resin material with a pH value of about 14. The paste was taken out of the container, mixed with a copious amount of deionized water, and subjected to centrifugation at 5000 rpm for 10 min. The resulting clear supernatant solution (pH about 14) was decanted to obtain a wet off-white paste. The mixing with deionized water, centrifugation and decanting steps were repeated until the supernatant liquid attained near neutral pH. About 50 ml of deionized water was added to the paste and the mixture was then homogenized with a homogenizer (IKA T 25 digital ULTRA-TURRAX®) at 10000 rpm for about 10 min. The mixture was centrifuged and the supernatant was decanted to give a wet off-white paste. The dynamic light scattering experiments indicated that the product had an average particle size (Z-average) of about 300 nm. FIG. 2 shows a TEM image of the product, showing the aggregates 200. It is noted that the paste was thixotropic. The wet paste did not show particle settlement for at least a few months and kept its thixotropic property. The measured zeta potential was about −40 to about −47 mV in the pH range from about 4 to about 12.

### Example 2

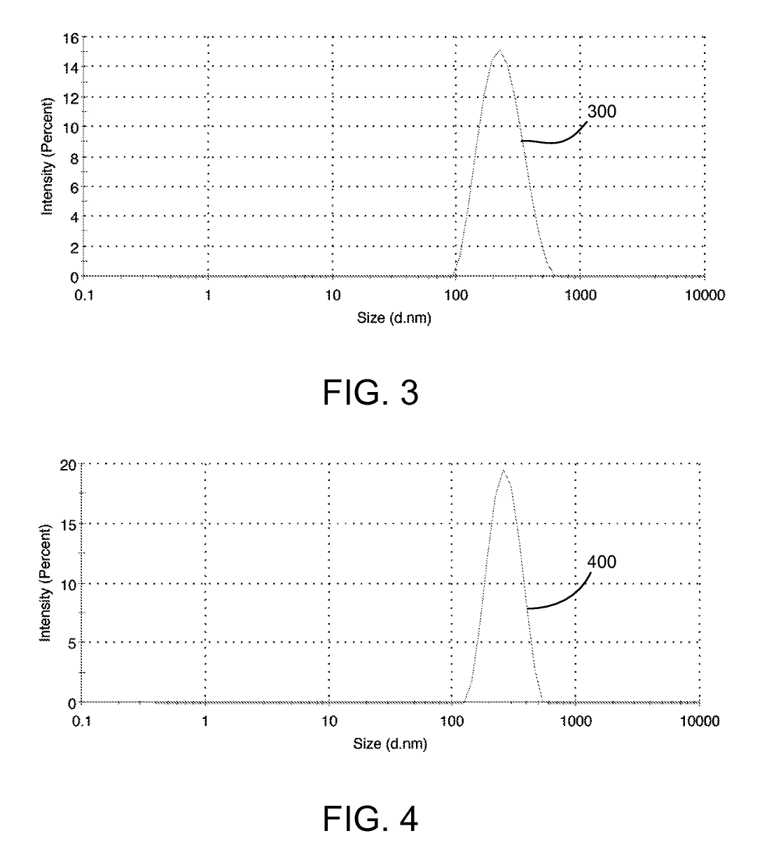

6 g of NaOH was dissolved in 11 ml of deionized water in an ice bath. 15.5 g of sodium silicate (˜10.6% Na₂O, ˜26.5% SiO₂) was added subsequently into the above solution and stirred in a water bath with a laboratory mixer at 800 rpm, until the solution became homogeneous by visual inspection. Into the solution, 7.6 g of metakaolin (MetaMax®) was added and stirring was continued at 800 rpm for about 40 min, which yielded a geopolymer resin having approximate nominal Na:Al:Si atomic ratios of 3:1:2. This geopolymer resin was poured into a polypropylene tube, and sealed airtight, and heated at 60° C. for six hours in a lab oven to give a paste-like geopolymer resin material with a pH value of about 14. The paste was taken out of the container, mixing with a copious amount of deionized water, and subjected to centrifugation at 5000 rpm for 10 min. The resulting clear supernatant solution (pH about 14) was decanted to obtain a wet off-white paste. The mixing with deionized water, centrifugation and decanting steps were repeated until the supernatant liquid attained near neutral pH. A portion of the paste was transferred into a vial and ultrasonicated with a copious amount of deionized water for 30 minutes. The dynamic light scattering experiments indicated an average particle size (Z-average) about 210 nm. FIG. 3 shows the particle size distribution 300 from the dynamic light scattering experiment. The paste was further freeze-dried to give a fine powdery material. A portion of the powder was transferred into a vial and ultrasonicated with a copious amount of deionized water for 30 minutes. The dynamic light scattering experiments indicated an average particle size (Z-average) about 250 nm. FIG. 4 shows the particle size distribution 400 from the dynamic light scattering experiment.

### Example 3

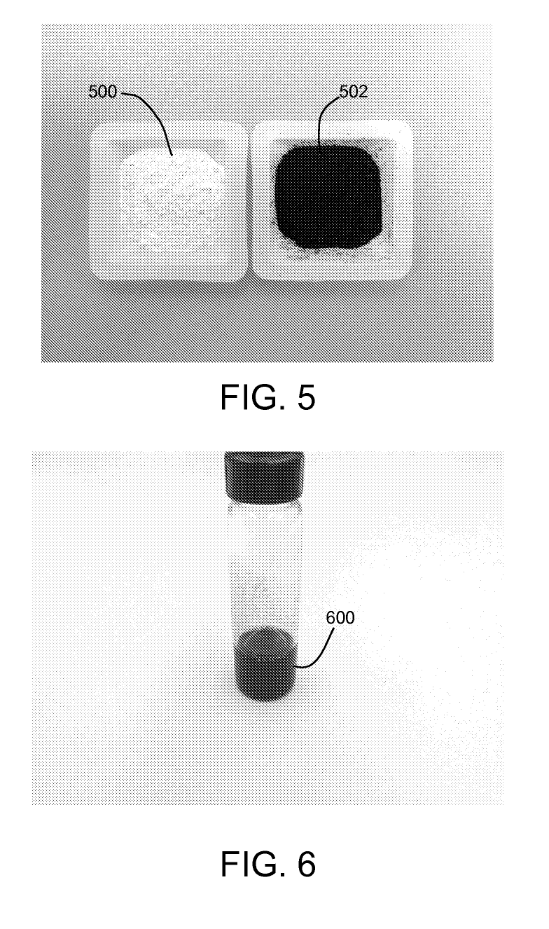

About 2 g of the wet off-white paste product prepared as in Example 1 was added to 20 mL of an aqueous solution of methylene blue, a cationic dye. The mixture was hand-shaken for 10 minutes and subjected to centrifugation at 5000 rpm for 10 min. The resulting blue supernatant solution was decanted to obtain a deep blue precipitate. The mixing with fresh deionized water, centrifugation and decanting steps were repeated until the supernatant liquid was light blue in color. The blue precipitate was collected, air-dried and gently crushed into a fine powder. FIG. 5 shows the original off-white paste 500 and the product 502 dried in a lab oven. About 0.5 mg of the blue powder product was then added in a 2 mL of extra-heavy paraffin oil and ultrasonicated for 10 minutes to disperse the powder particles in the liquid. As shown in FIG. 6, the dispersion 600 had a uniform color throughout.

### Example 4

A suitable amount of deionized water was added the wet off-white paste product prepared as in Example 1 to give a dispersion having about 21 wt % solid content in dry mass. The viscosity of the dispersion was about 2200 cP at spindle speed of 10 RPM at room temperature from the viscosity measurement with Brookfield DVII+Pro EXTRA viscometer. Another dispersion having about 20 wt % solid content in dry mass showed a viscosity of ˜1500 cP at the same condition.

### Example 5

A suitable amount of deionized water was added to the wet off-white paste product prepared as in Example 1 to give a dispersion having about 19 wt % solid content in dry mass. The viscosity of the dispersion was measured with Brookfield DVII+Pro EXTRA viscometer at room temperature at various spindle speeds. The viscosity decreased as the spindle speed increased, indicating a thixotropic behavior of the dispersion (863 cP at 10 RPM; 654 cP at 20 RPM; 382 cP at 50 RPM; and 247 cP at 100 RPM).

### Example 6

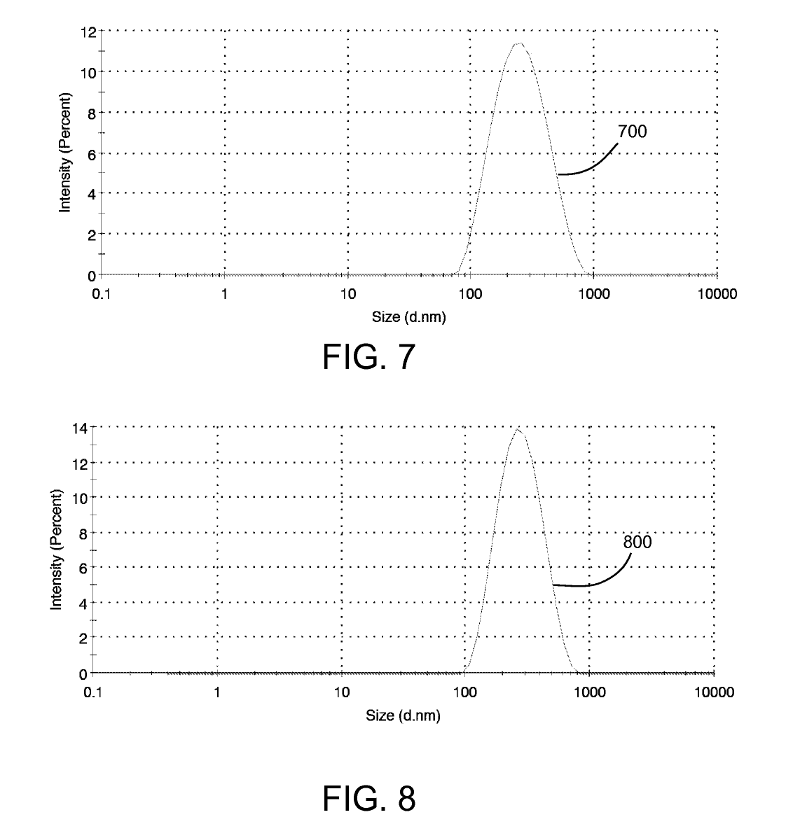

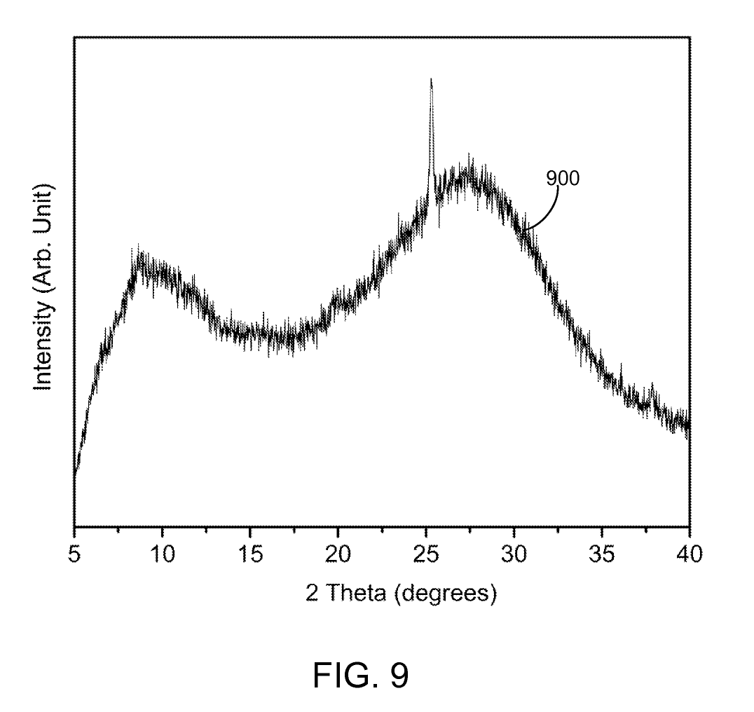

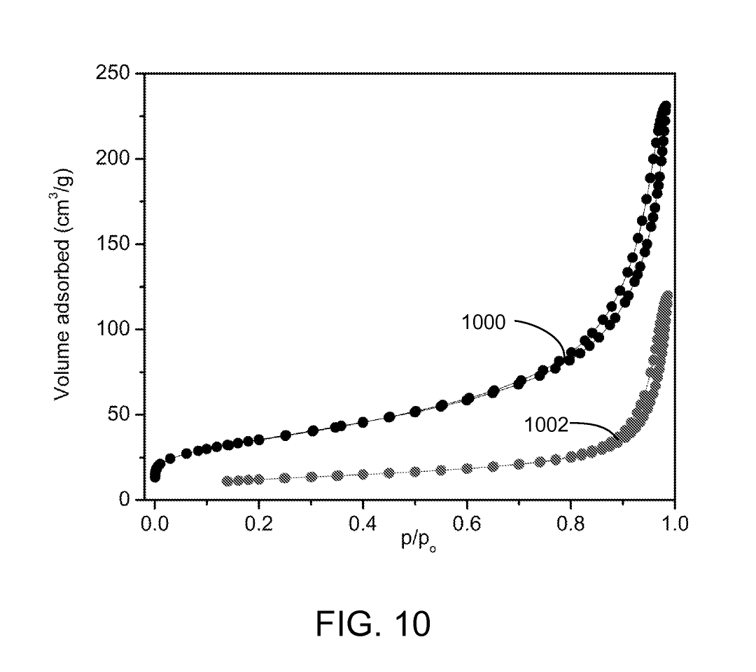

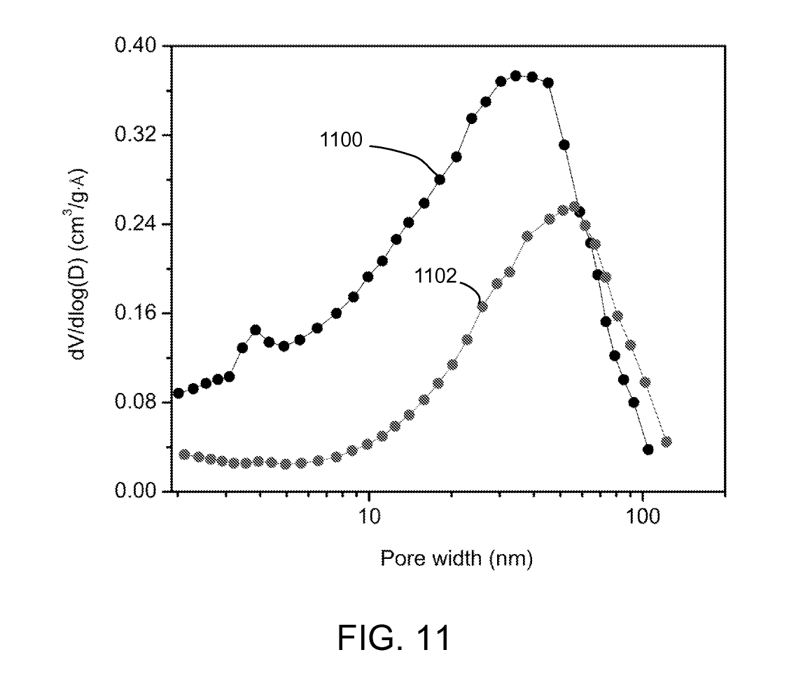

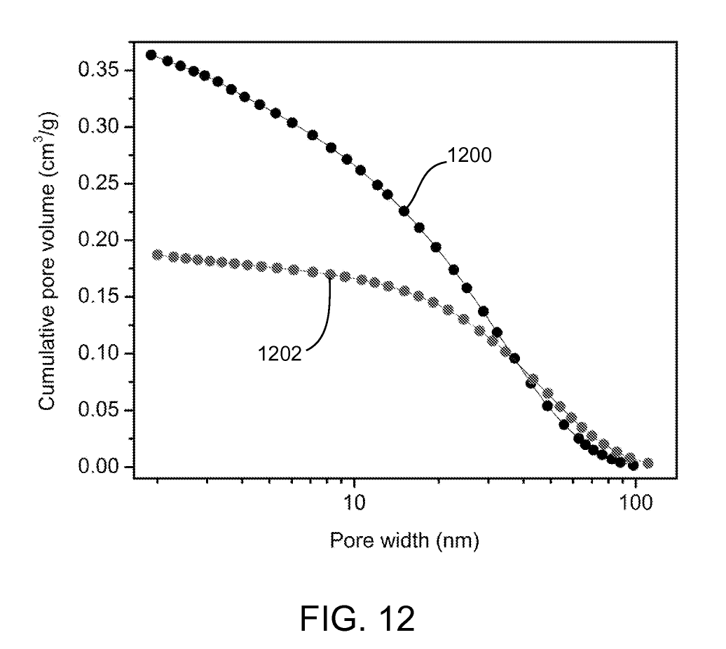

A geopolymer product was synthesized by following the process in Example 1 except for different purification and drying processes. The wet off-white paste was transferred into a large plastic beaker and 1 M HCl solution was added to the paste while stirring until the pH of the mixture became about 8. The mixture was subjected to centrifugation at 5000 rpm for 10 min. The resulting clear supernatant solution was decanted to obtain a wet off-white paste. The mixing with deionized water, centrifugation, and decanting steps were repeated until the supernatant liquid attained a pH near neutral. About 50 ml of deionized water was added to the paste and the mixture was then homogenized with a homogenizer (IKA T 25 digital ULTRA-TURRAX®) at 10000 rpm for about 10 min. The mixture was centrifuged and the supernatant was decanted to give a wet off-white paste. A portion of the paste was transferred into a vial and ultrasonicated with a copious amount of deionized water for 30 minutes. The dynamic light scattering experiments indicated an average particle size (Z-average) of about 270 nm. FIG. 7 shows the particle size distribution 700 from the dynamic light scattering experiment. A portion of the paste was further freeze-dried to give a find powdery material. Another portion of the paste was dried in a lab oven at around 110° C. overnight. A portion of the freeze-dried powder was transferred into a vial and ultrasonicated with a copious amount of deionized water for 30 minutes. The dynamic light scattering experiments indicated an average particle size (Z-average) about 290 nm. FIG. 8 shows the particle size distribution 800 from the dynamic light scattering experiment of the freeze-dried sample re-dispersed in water. FIG. 9 shows the powder X-ray diffraction pattern 900 of the freeze-dried sample, indicating the amorphous nature of the product except a single peak at 2θ˜25°, which is attributed to TiO₂ impurity in the metakaolin precursor. FIG. 10 shows the N₂ sorption isotherms of the freeze-dried sample (plot 1000) along with the oven-dried sample (plot 1002). FIG. 11 shows the corresponding the BJH pore distributions of the freeze-dried sample (plot 1100) along with the oven-dried sample (plot 1102). FIG. 12 shows the corresponding the BJH cumulative pore volume as a function of the pore width of the freeze-dried sample (plot 1200) along with the oven-dried sample (plot 1202).

### Example 7

A geopolymer was synthesized by following the process in Example 1 except that 10% of the Si atoms were from diphenyl diethoxysilane and the geopolymer resin was heated for 24 hours. The product was collected after repetitive washing with deionized water until the pH of the supernatant was about 7. The wet product was homogenized, dried, and redispersed by ultrasonication with a copious amount of deionized water for 30 minutes. The dispersion showed rapid settlement, indicating a higher hydrophobicity than the sample in Example 1.

### Example 8

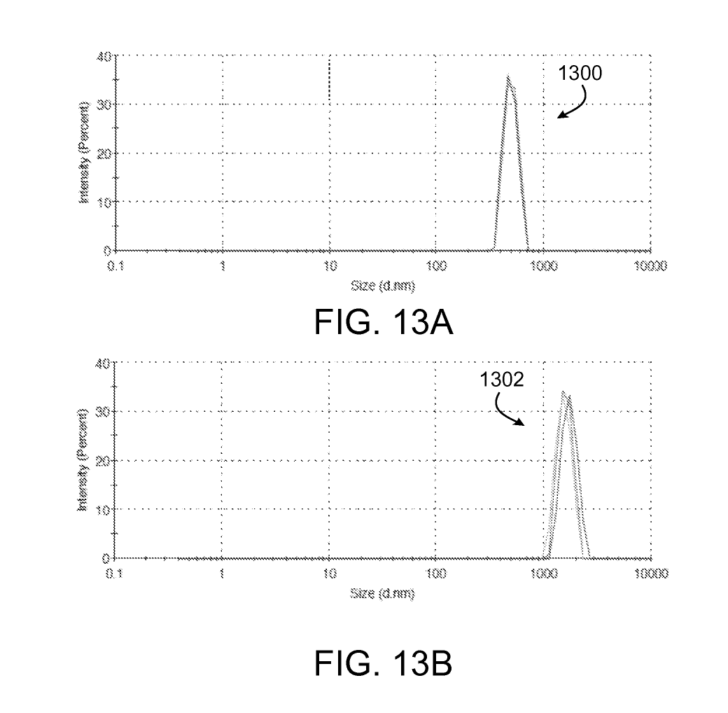

A geopolymer was synthesized by following the process in Example 1 except that the geopolymer resin was heated for 6 hours. The product was collected after repetitive washing with deionized water until the pH of the supernatant was about 7. The wet product was ball-milled together with 10 wt % cetyltrimethylammonium bromide ((C₁₆H₃₃)N(CH₃)₃Br, CTAB) for 6 hours. The product was then washed and dried in a lab oven at 110° C. A small portion of the dried product was redispersed in methanol and water separately through ultrasonication for about 10 min. FIGS. 13A and 13B show the particle size distributions 1300 and 1302, respectively, from the dynamic light scattering experiments for the sample in methanol (FIG. 13A) and in water (FIG. 13B). The average particle sizes (Z-average) were about 470 and 1550 nm, respectively, indicating that the product has a better dispersibility in methanol than in water.

### Example 9

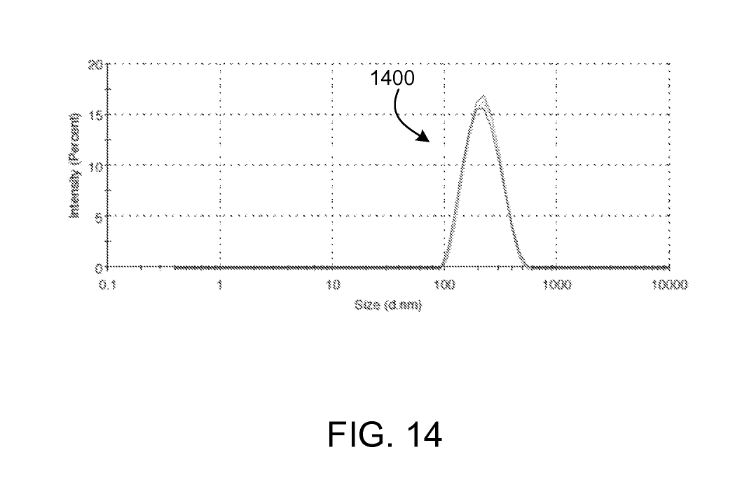

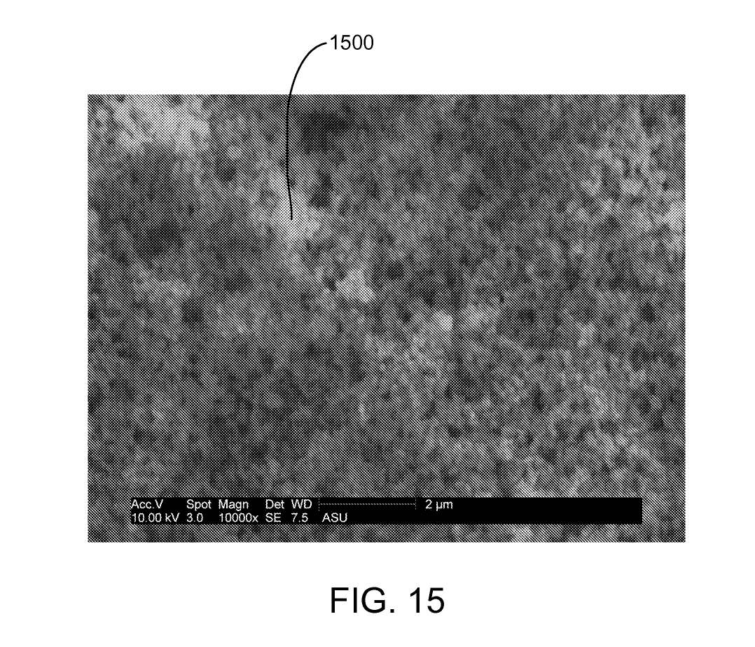

A geopolymer was synthesized by following the process in Example 1 except that the geopolymer resin was heated for 6 hours and then aged at room temperature for two days. About 16 g of the wet product (pH˜14) was transferred into a mortar and it was ground while a total of 9 ml of a saturated Zn(NO₃)₂ solution was added dropwise, which reduced the pH of the wet product to about 8. The product was then washed repeatedly with deionized water and the dynamic light scattering experiment indicated an average particle size (Z-average) of about 210 nm. FIG. 14 shows the particle size distribution 1400 from the dynamic light scattering experiment. FIG. 15 shows a scanning electron micrograph of the product, exhibiting agglomerates 1500 larger than about 100 nm. The atomic ratio of Zn:Al was about 1:1.1 based on the energy-disperse spectroscopic elemental analysis. The product showed a total pore volume of 0.5 cm³/g, a surface area of 243 m²/g and a desorption average pore width of 8.6 nm. The calculated micropore volume and surface area were 0.06 cm³/g and 127 m²/g, respectively. The BJH pore size distribution from the desorption branch showed a peak maximum at about 40 nm.

### Example 10

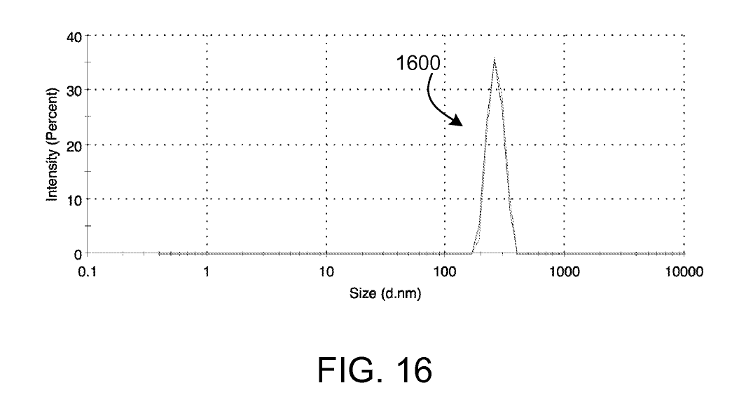

9 g of NaOH and 23.4 g of water glass were dissolved in 23.4 ml of deionized water in a polypropylene beaker. After the solution had cooled, 11.5 g of metakaolin (MetaMax® from BASF) was slowly added into the solution while stirring. The resulting mixture was homogenized with a mechanical mixer (IKA® RW 60 digital mixer) at 800 rpm for about 40 min to obtain a visually homogeneous and free flowing resin (“geopolymer resin”). Canola oil was added to the geopolymer resin and the mechanical stirring at 800 rpm was continued for additional 10 min to give a homogeneous blend. The blend was poured into 50 ml polypropylene tubes and tightly closed with lids. The closed tubes were then placed in a laboratory oven at 90° C. for 36 hrs. After the heating, the product was taken out from the tubes and washed with hot water (90° C.) multiples times. The final product was collected via centrifugation. The pH of the supernatant was about 8. After drying at 110° C., the product showed a FAU structure from the powder X-ray diffraction studies. The product showed a total pore volume of ˜0.5 cm³/g and an external surface area of ˜120 m²/g. The calculated micropore volume and surface area were ˜0.3 cm³/g and ˜640 m²/g, respectively. The wet product was then ground in a planetary ball-mill at a speed about 500 rpm for about 3 hrs. FIG. 16 shows the particle size distribution 1600 from the dynamic light scattering experiments for the sample in water. The average particle size (Z-average) was about 260 nm.

Only a few implementations are described and illustrated. Variations, enhancements and improvements of the described implementations and other implementations can be made based on what is described and illustrated in this document.

1. A composition comprising:
porous aggregates comprising aluminosilicate nanoparticles, wherein:
an average particle size of the aluminosilicate nanoparticles is between about 5 nm and about 60 nm,
a majority of the porous aggregates have a particle size between about 50 nm and about 1 μm, and
a majority of the pores between the aluminosilicate nanoparticles in the porous aggregates have a pore width between about 2 nm and about 100 nm.

2. The composition of claim 1, wherein the mesopore volume of the porous aggregates is at least about 0.05 cc/g on the BJH cumulative pore volume from the desorption branch of the N₂ sorption isotherm, wherein the mesopore volume is the total pore volume of the pores having a pore width from about 2 to about 50 nm.

3. The composition of claim 1, wherein the mesopore volume of the porous aggregates contributes at least about 50% of the total pore volume of the aggregates from the pores having a pore width between about 2 nm and about 100 nm based on the BJH cumulative pore volume from the desorption branch of the N₂ sorption isotherm.

4. The composition of claim 1, wherein the specific external surface area of the porous aggregates is between about 10 m²/g and about 300 m²/g, wherein the specific external surface area of the porous aggregates is the total specific surface area minus the specific micropore surface area.

5. The composition claim 1, wherein the specific micropore surface area of the porous aggregates is between about 100 m²/g and about 700 m²/g and the aluminosilicate has zeolitic micropores.

6. (canceled)

7. The composition of claim 1, wherein the aluminosilicate nanoparticles of each of the porous aggregates are interconnected through chemical bonds throughout the formation of the porous aggregates.

8. The composition of claim 1, wherein the porous aggregates are formed in a geopolymerization process.

9. The composition claim 1, wherein the porous aggregates are formed by a process comprising:
providing a geopolymer resin containing up to about 85 mol % water;
optionally keeping the geopolymer resin at a temperature up to about 60° C. for up to about a week;
heating the geopolymer resin in a closed container at a temperature up to about 100° C. for up to about a week to yield a semi-liquid or a semi-solid;
removing the heat and treating the semi-liquid or the semi-solid to form a dispersion or suspension comprising the porous aggregates and reducing the pH of the dispersion or suspension to a range from about 3 to about 10; and
optionally concentrating a solid component or collecting a solid product from the dispersion or suspension.

10. The composition of claim 9, wherein the geopolymer resin comprises an organic functional group.

11. The composition claim 9, wherein reducing the pH is achieved by combining the dispersion or suspension with a solution of a metal ion that forms an oxide, hydroxide, hydrous oxide, or combination thereof in contact with hydroxide ions.

12. (canceled)

13. The composition claim 1, wherein the aluminosilicate nanoparticles exhibit zeolitic micropores.

14. The composition claim 1, wherein the aluminosilicate nanoparticles exhibit zeolitic micropores with a SOD, FAU, EMT, or LTA structure.

15. The composition of claim 1, wherein the porous aggregates are modified so that the pore surface of the porous aggregates is covered or impregnated partially or completely with one or more organic molecules, surfactants, polymers, inorganic molecules or nanoparticles, molecules of a biological origin, or a combination thereof, or wherein the porous aggregates are modified so that the alkali ions in the aluminosilicate aggregates are exchanged partially or completely with other metal ions or protons.

16. (canceled)

17. The composition of claim 1, wherein the porous aggregates absorb water or moisture, absorb oil or organic molecules, neutralize or scavenge an acid, retard fire propagation, and/or release metal ions or metal nanoparticles that have an antibacterial effect.

18. The composition of claim 1, wherein the porous aggregates comprise up to about 0.5 wt % conjugate anions of an acid including sulfates, nitrates, chlorides, and acetates.

19. The composition of claim 1, wherein the absolute value of the zeta potential of the porous aggregates is at least about 30 mV in the pH range not lower than about 3 and not higher than about 14.

20. An aqueous medium, organic medium, polymeric medium, or elastomeric medium comprising the porous aggregates of claim 1.

21. The aqueous medium, organic medium, polymeric medium, or elastomeric medium of claim 20, wherein the porous aggregates provide a thixotropic property to the aqueous medium, organic medium, polymeric medium, or elastomeric medium.

22. A material comprising the porous aggregates of claim 1, wherein the material is an adhesive, a sealant, a colorant, an ink, an ink for ink-jet printers, a toner, a paint, a coating, a defoamer, a grease, a paper, a cement, a thermal insulating material, a sound proof, a rubber, a silicone rubber, a plastic, an animal feed, an animal nutrient, an antibiotic, an antimicrobial agent, a fertilizer, a pesticide, a gel, an antacid, a food item, a fire retardant, a cosmetic, a cream, a lotion, a sealing agent, an adsorbent, a gas adsorbent, a carbon dioxide adsorbent or separator, a gas purifier, a deodorant, a detergent, a cat litter, a catalyst, an oxygen concentrator, an ion exchanger, a sulfur scavenger, an acid scavenger, a radionuclide sorbent, or a desiccant, and wherein the material is in the form of a liquid, a semi-liquid, a paste, a semi-solid, powder, granules, beads, pellets, film, coating, fibers, hollow fibers, wires, strings, tubing, foams, or monoliths.

23. (canceled)

24. An article comprising the porous aggregates of claim 1, wherein the article is a tire, a rubber belt, a rubber seal, a rubber tube, footwear, a polystyrene foam, a polyurethane foam, a fire extinguisher, a tooth paste, a drug tablet, a membrane, a dehumidifier, or a heat exchanger.
